(19) United States
(12) Patent Application Publication
(10) Pub. No.: US 2026/0308884 A1
(43) Pub. Date: Oct. 8, 2026

(54) System And Method For Coaching An Operator Of A Work Machine

(71) Applicant: Caterpillar Inc., Peoria, IL (US)

(72) Inventors: Frederic Christian Predemoiser, Champfromier (FR); Arick Matthew Bakken, Raleigh, NC (US); Adam Martin Nackers, Washington, IL (US)

(21) Appl. No.: 19/482,321

(22) PCT Filed: Apr. 17, 2024
(86) PCT No.: PCT/US2024/024844

§ 371 Date: Nov. 7, 2025

(30) Foreign Application Priority Data
May 16, 2023 (GB) 2307255.6

(51) Int. Cl. E02F 9/24; E02F 9/26; G09B 19/16

(52) U.S. Cl. CPC E02F 9/24; E02F 9/26; G09B 19/167

(57) ABSTRACT

A system for coaching an operator of a work machine includes a sensing system configured to detect data related to an operation of at least one first system of the work machine and a controller operatively coupled to the sensing system. The controller is configured to receive a first input to activate a coaching mode and activate one or more coaching levels from a plurality of coaching levels in the coaching mode in response to a second input. The controller is configured to determine an operational state of the at least one first system based on the data and issue one or more correction signals corresponding to the one or more coaching levels when the operational state of the at least one first system meets a predefined condition or when a parameter associated with the operational state of the at least one first system meets or exceeds a parameter threshold.

### TECHNICAL FIELD

The present disclosure relates to a system and a method for coaching an operator of a work machine. More particularly, the present disclosure relates to a system and a method for onsite coaching of the operator of the work machine.

### BACKGROUND

Work machines, such as dozers, tractors, motor graders, and excavators, are commonly used machines in industries, such as construction and mining. These machines are designed to perform a variety of tasks on construction sites, including excavation, grading, and hauling. Certain operators, such as novice operators often struggle to operate the machines safely and efficiently. In addition, even experienced operators can face challenges from time to time when operating the work machines.

U.S. Pat. No. 11,066,077 relates to a vehicle-initiated cadenced operator interaction system that introduces an operational concept to a vehicle operator via a machine-initiated interaction. An interaction is initiated by the industrial vehicle according to a cadence that provides a gap between interactions so that the operator can demonstrate the behavior associated with the introduced concept. The vehicle controller actively analyzes industrial vehicle data associated with the content of the interaction(s), and evaluates the data against pre-defined operational criteria to determine whether the operator is demonstrating the appropriate skill/behavior associated with the interaction(s). Responsive to the operator's demonstrated ability, the system can modify operation of the vehicle to tune the industrial vehicle to the operator.

### SUMMARY

In an aspect, the present disclosure relates to a system for coaching an operator of a work machine. The system includes a sensing system configured to detect data related to an operation of at least one first system of the work machine and a controller operatively coupled to the sensing system. The controller is configured to receive a first input to activate a coaching mode and activate one or more coaching levels from a plurality of coaching levels in the coaching mode in response to a second input. The controller is further configured to determine an operational state of the at least one first system based on the data and issue one or more correction signals corresponding to the one or more coaching levels when the operational state of the at least one first system meets a predefined condition or when a parameter associated with the operational state of the at least one first system meets or exceeds a parameter threshold.

In another aspect, the present disclosure relates to a method for coaching an operator of a work machine. The method includes detecting, by a sensing system, data related to an operation of at least one first system of the work machine and receiving, by a controller, a first input to activate a coaching mode. The method further includes activating, by the controller, one or more coaching levels from a plurality of coaching levels in the coaching mode in response to a second input and determining, by the controller, an operational state of at least one first system based on the data. Further, the method includes issuing, by the controller, one or more correction signals corresponding to the one or more coaching levels when the operational state of the at least one first system meets a predefined condition or when a parameter associated with the operational state of the at least one first system meets or exceeds a parameter threshold.

### BRIEF DESCRIPTION OF THE DRAWINGS

FIG. 1 is a view of an exemplary work machine, according to an embodiment of the present disclosure;

FIG. 2 is a diagrammatic view of a system for coaching an operator of the work machine, according to an embodiment of the present disclosure;

FIG. 3 illustrates an exemplary operator coaching mode interface for activating a coaching mode for coaching the operator, according to an embodiment of the present disclosure;

FIG. 4 illustrates an exemplary operator coaching level interface for activating a coaching level in the coaching mode, according to an embodiment of the present disclosure; and

FIG. 5 is a method for coaching the operator of the work machine, in accordance with an embodiment of the present disclosure.

### DETAILED DESCRIPTION

Reference will now be made in detail to specific embodiments or features, examples of which are illustrated in the accompanying drawings. Wherever possible, the same reference numbers will be used throughout the drawings to refer to the same or the like parts.

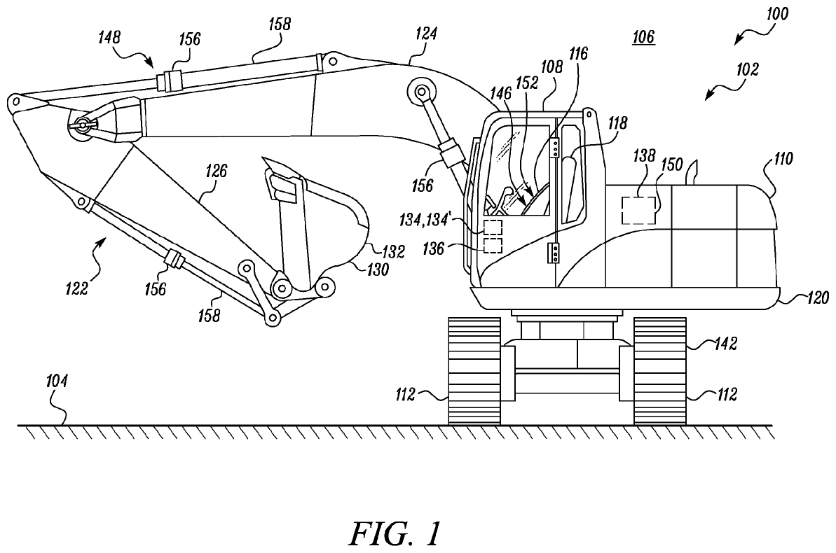

Referring to FIG. 1, an exemplary work machine 100 is shown. The work machine 100 may perform a variety of tasks associated with an industry such as construction, mining, farming, transportation, or any other industry known in the art. As an example, the work machine 100 is embodied as an excavator 102 configured to perform excavation tasks, such as, digging, loading, and/or unloading materials (e.g., earthen material such as ore, coal, or other minerals) at a worksite 106. Alternatively, the work machine 100 may be any machine including, but not limited to, a backhoe loader, a wheel loader, an industrial loader, a dozer, a mining truck, an articulated truck, a track type tractor, a forklift, a crane, skid steer loaders, compact track loaders, multi-terrain loaders, and so on.

Although references to the excavator 102 are used, aspects of the present disclosure may also be applicable to other work machines, such as backhoe loaders, wheel loaders, industrial loaders, dozers, mining trucks, articulated trucks, track-type tractors, forklifts, cranes, skid steer loaders, compact track loaders, multi-terrain loaders, or any other machines known to those skilled in the art, and references to the excavator 102 in the present disclosure is to be viewed as purely exemplary.

The work machine 100 includes a main frame 120. The main frame 120 may support and/or accommodate one or more components/assemblies of the work machine 100. For example, an operator cabin 108 may be supported over the main frame 120. The operator cabin 108 may facilitate stationing of one or more operators therein, to monitor one or more operations of the work machine 100 performing a task (e.g., excavation task). To this end, the operator cabin 108 may house one or more operator seats (e.g., operator seat 118) secured on a floor of the operator cabin 108. The work machine 100 may also include a counterweight 110 to balance a weight of the work machine 100, e.g., when the work machine 100 may be lifting or carrying a relatively heavy load. The counterweight 110 may be positioned adjacent to the operator cabin 108, on the main frame 120 of the work machine 100.

The operator cabin 108 may house various components and controls of the work machine 100, access to one or more of which may help the operators to control the machine's movement and/or operation. For example, the operator cabin 108 may include an interface (not shown) that may be viewable, and operable by the operator of the work machine 100. The interface may be mounted to a dashboard (not shown) of the work machine 100 within the reach of the operator. The interface may include an input device 134 to receive one or more inputs to control one or more operations associated with the work machine 100 from the operator. The input device 134 may include a joystick 134, a touch screen, a switch, or a combination thereof. The interface may also include an output device (not shown) to provide data and/or alert associated with the operations of the work machine 100 to the operator. The output device may include one or more of a display, an audio device, or any other device operable to provide the data and/or alert to the operator. In some embodiments, the input device 134 and the output device may together embody a single integral component such as, for example, a touch screen device. In some embodiments, the interface may be located at a remote location such that the work machine 100 may be controlled remotely.

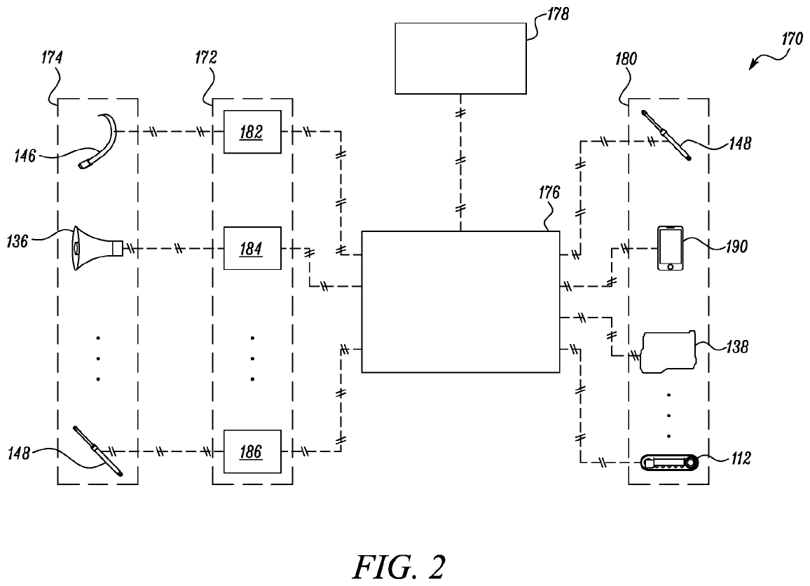

The work machine 100 may also be equipped with communication device 190 (shown in FIG. 2), such as two-way radios or cellular phones, which can be used to communicate with workers or operators outside of the work machine 100. In some embodiments, the communication device 190 may be integral and/or built-in to one or more systems/sub-systems of the work machine 100. Alternatively, the communication device 190 may be mounted on the exterior of the work machine 100 or may be carried by the operator. For example, the communication device 190 may be mounted on or beside the interface of the operator cabin 108.

The work machine 100 may also include a machine horn 136. The machine horn 136 may be used to alert workers and/or other machines at the worksite 106, e.g., of a working or moving status of the work machine 100. The machine horn 136 may be activated by a button or a switch located on or around the interface of the work machine 100. Upon actuation of the button or switch, the machine horn 136 may produce an audible sound to alert other workers and/or work machines at the worksite 106. The machine horn 136 may be located at any suitable site of the work machine 100 from where the machine horn 136 may remain audible. As an example, the machine horn 136 may be located on any outer surface, such as, an exterior of the main frame 120 or the operator cabin 108 of the work machine 100. In some cases, the machine horn 136 may be located at the top of the operator cabin 108, such that the alert can be easily heard from a distance.

The work machine 100 may further include traction devices 112. The traction devices 112 may support the main frame 120 on the ground 104 at the worksite 106. In an example as shown in FIG. 1, the traction devices 112 may be coupled to and be supported by the main frame 120. The traction devices 112 may include a set of crawler tracks 142. The crawler tracks 142 may be configured to move and transport the work machine 100 from one location to another at the worksite 106, according to a customary practice known in the art. In the present embodiment, two crawler tracks 142 are provided, one on each side of the work machine 100. In other embodiments, the traction devices 112 may include wheeled units (not shown) provided either alone or in combination with the crawler tracks 142.

The work machine 100 may also include other sub-systems. For example, the work machine 100 may include an implement system 122, a power system 138, a seat belt locking system 146, and a hydraulic system 148. For the purposes of the present disclosure, exemplary aspects related to each of these systems shall now be discussed. Variations to such discussions can be contemplated by those of skill in the art.

The implement system 122 may be configured to perform various tasks, such as, digging and lifting, of load. In an exemplary embodiment, as shown in FIG. 1, the implement system 122 may include a work tool 130, which may be supported by a boom 124 and a lifting arm 126. The boom 124 may be pivotally coupled to the main frame 120 and may be configured to move (e.g., pivot or rotate) with respect to the main frame 120 to raise or lower the lifting arm 126 and/or the work tool 130 with respect to the ground 104. The lifting arm 126 may be coupled to the boom 124 in a manner that permits the lifting arm 126 to move (e.g., pivot or rotate) with respect to the boom 124. The work tool 130 may be coupled to the lifting arm 126 in a manner that permits the work tool 130 to move (e.g., pivot or rotate) with respect to the lifting arm 126. In the present embodiment, as shown in FIG. 1, the work tool 130 includes a bucket 132. While the work tool 130 is depicted as the bucket 132, it may be understood that the work tool 130 may represent or include, but not limited to, blades, forks, and multiple varieties of buckets, such as toothed buckets, ejector buckets, side dump buckets, demolition buckets, and the like.

The power system 138 may be configured to provide power needed to operate various components of the work machine 100. The power system 138 may include an engine, such as an internal combustion engine powered by combusting a fuel such as, but not limited to, gasoline, diesel, natural gas, or a similar fuel, or any combination thereof. In some embodiments, the power system 138 may additionally, or optionally, include electrical power storage devices like batteries, an electric motor, fuel cells powered by hydrogen, or any other power source, that may be applied either alone or in combination with the internal combustion engine. The power system 138 may be provided within a power compartment 150 in the counterweight 110 of the work machine 100.

The seat belt locking system 146 may include a seat belt assembly 152 configured to secure an operator of the work machine 100 in the operator seat 118. The seat belt assembly 152 may include a seat belt 116 with a tongue (not shown) disposed on the seat belt 116 and a seatbelt buckle assembly (not shown) to receive the tongue therein and secure the seat belt 116 with the operator seat 118 such that the operator may be securely grasped and retained within the operator seat 118.

The hydraulic system 148 may be configured to control various functions of the work machine 100. As an example, the hydraulic system 148 may be applied to move and manipulate one or more of the boom 124, the lifting arm 126, and the work tool 130, with respect to each other. The hydraulic system 148 may include a hydraulic pump (not shown), a hydraulic cylinder 156, and hydraulic lines 158 for transmitting hydraulic fluid throughout the work machine 100 to control the functions of the work machine 100. The hydraulic pump may be used to pressurize and supply the hydraulic fluid through the hydraulic lines 158 to the hydraulic cylinder 156. The hydraulic cylinder 156 may be located within various parts, for example, within the boom 124, the lifting arm 126, and the work tool 130, of the work machine 100, to perform tasks such as lifting or moving heavy loads.

It should be noted that the work machine 100 may include various other sub-systems, such as a transmission assembly (not shown), a heating, ventilation, and air conditioning (HVAC) assembly (not shown), and the like. However, such other sub-systems are not being discussed as the present disclosure is not limited by any such sub-systems.

FIG. 2 illustrates a system 170 for coaching the operator of the work machine 100. The system 170 includes a sensing system 172 configured to detect data related to an operation of at least one first system 174 of the work machine 100. As shown in FIG. 2, the first system 174 may include one or more systems, sub-systems, assemblies, and components, such as, but not limited to, the seat belt locking system 146, the machine horn 136, and the hydraulic system 148, of the work machine 100. Although FIG. 2 shows the first system 174 as the seat belt locking system 146, the machine horn 136, and the hydraulic system 148, it may be contemplated that the first system 174 may include any other assembly, system, sub-system, or component of the work machine 100.

The sensing system 172 may include sensors 182, 184, 186. The sensors 182, 184, 186 may be coupled (e.g., correspondingly coupled or associated with) to the first systems 174 to detect the data related to the operation of the first systems 174. In an embodiment, the sensing system 172 may include a seat belt sensor 182 operatively coupled to the seat belt locking system 146 to detect data related to the connection and disconnection of the tongue with the seatbelt buckle assembly of the seat belt assembly 152. For example, the seat belt sensor 182 may be located in the seatbelt buckle assembly and detects the connection and disconnection of the tongue with the seatbelt buckle assembly. For example, a connection of the tongue with the seatbelt buckle assembly may be achieved when the tongue is inserted into the seatbelt buckle assembly. Similarly, a disconnection of the tongue with the seatbelt buckle assembly may be achieved when the tongue is removed from the seatbelt buckle assembly. The seat belt sensor 182 may include one or more of a switch, a relay, a timer, or any electromechanical device so as to detect the connection and disconnection of the tongue with the seatbelt buckle assembly.

The sensing system 172 may include a machine horn sensor 184 operatively coupled to the machine horn 136 to detect data related to the actuation of the machine horn 136. For example, the machine horn sensor 184 may include a pressure sensor and/or vibration sensor that detects the sound waves generated by the machine horn 136. In some embodiments, the machine horn sensor 184 may utilize a relay or an equivalent circuit to detect data related to the actuation of the machine horn 136, using various techniques known in the art. For example, the machine horn 136 may include any audible sensor that can detect and/or derive a decibel level of a sound associated with the alert generated by the machine horn 136.

In an embodiment, the sensing system 172 may include a hydraulic sensor 186 coupled to the hydraulic system 148 to detect data related to a change in hydraulic pressure or flow rate of the hydraulic system 148. When a hydraulic system 148 is engaged, the hydraulic pressure in the hydraulic system 148 and the flow rate of the hydraulic fluid increase. The hydraulic sensor 186 may be located in different parts of the hydraulic system 148 and detects the data related to these changes. The hydraulic sensor 186 may include a pressure sensor, a flow sensor, or any sensor capable of detecting the pressure and flow of the hydraulic fluid.

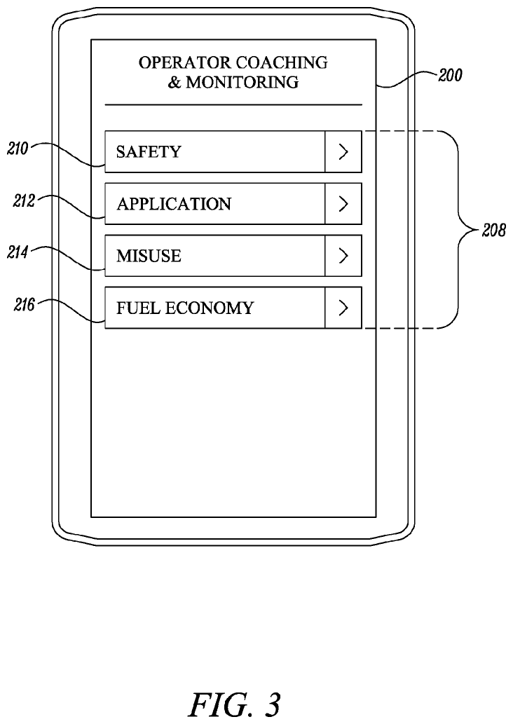

The system 170 further includes a controller 176 operatively coupled to the sensing system 172. The controller 176 is configured to activate a coaching mode for coaching the operator of the work machine 100 in response to a first input. The first input may be supplied by the operator to the controller 176 of the work machine 100 by way of the interface. The coaching mode may correspond to one or more modes provided in the work machine 100 that enables the coaching of the operator of the work machine 100. For example, as shown in FIG. 3, the coaching modes 208 displayed on an operator coaching mode interface 200 (which may be part of the interface) may include a safety mode 210, an application mode 212, a misuse mode 214, and a fuel economy mode 216. Each of the coaching modes 208 provide coaching or feedback to the operator of the work machine 100.

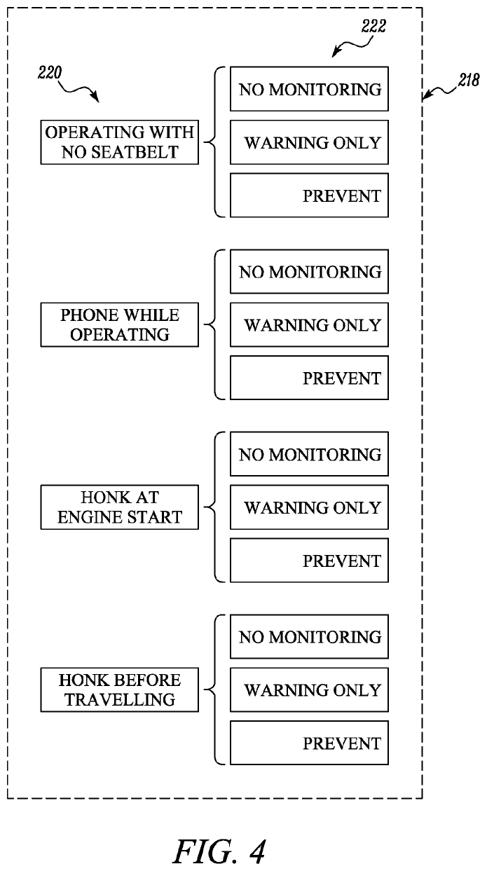

As shown in FIGS. 3 and 4, the safety mode 210 of the coaching mode 208 provides coaching or feedback on safety features 220 which may enable the operator to use the work machine 100 safely, e.g., safety of the operator and/or other workers at the worksite 106. For example, the safety features 220 corresponding to the safety mode 210 includes various sub-features, e.g., “operating with no seatbelt”, “phone while operating”, “honk at engine start”, and “honk before travelling”. Similarly, the application mode 212 provides coaching related to a functioning of the work machine 100; the misuse mode 214 provides coaching related to how to prevent misuse of the work machine 100; and the fuel economy mode 216 provides coaching on how to improve a fuel economy of the work machine 100. Aspects related to the present disclosure may be focused mainly on the safety mode 210, although similar and/or identical aspects may be applicable in the other modes as well, and/or the same may be contemplated by those skilled in the art based on the present disclosure.

Referring back to FIG. 2, the controller 176 may be configured to display the operator coaching mode interface 200 (shown in FIG. 3), to enable a user (e.g., the operator or a worksite supervisor or any interested personnel) to provide (e.g., manually provide via the interface) the first input associated with the activation of the desired coaching mode 208 (shown in FIG. 3). For example, the first input may correspond to a selection of the one or more coaching modes 208 displayed on the operator coaching mode interface 200 (shown in FIG. 3).

The controller 176 is further configured to activate one or more coaching levels from a plurality of coaching levels in the coaching mode 208 (shown in FIG. 3) in response to a second input. The coaching level may correspond to different degrees or intensities of coaching that can be provided to the operator. For example, as shown in FIG. 4, the coaching levels 222 corresponding to the various safety features 220 of the safety mode 210 includes levels referred to as “no monitoring”, “warning only”, and “prevent”. Each of the coaching levels 222 provides different degrees or intensities of coaching to the operator of the work machine 100. For example, when the coaching level corresponds to “no monitoring”, no coaching or alert is provided to the operator. Similarly, when the coaching level corresponds to “warning only”, a warning or a notification is provided to the operator. Further, when the coaching level corresponds to “prevent”, one or more operations of the work machine 100 are prevented from being performed.

Referring back to FIG. 2, in response to the first input, the controller 176 may be configured to display an operator coaching level interface 218 (shown in FIG. 4) via the interface, to enable a user (e.g., the operator or the worksite supervisor or any interested personnel) to provide the second input (e.g., via the interface) associated with the activation of the desired coaching level 222 (shown in FIG. 4). For example, the second input may correspond to a selection of the one or more coaching levels 222 displayed on the operator coaching level interface 218 (shown in FIG. 4).

In accordance with various embodiments, the operator coaching mode interface 200 (shown in FIG. 3) and the operator coaching level interface 218 (shown in FIG. 4) may be displayed on for example, the interface of the work machine 100. Alternatively, the operator coaching mode interface 200 (shown in FIG. 3) and the operator coaching level interface 218 (shown in FIG. 4) may be displayed on any remote device, such as a device associated with the worksite supervisor or any interested personnel, to activate the desired coaching mode 208 and the coaching levels 222.

The controller 176 may be configured to establish a datalink communication with the sensing system 172 over an on-board datalink communication channel of the work machine 100 and obtain the data related to the operation of the first system 174 of the work machine 100. The controller 176 is further configured to determine an operational state of the first system 174 based on the data and issue one or more correction signals corresponding to the one or more coaching levels 222 (shown in FIG. 4) when the operational state of the first system 174 meets a predefined condition or when a parameter associated with the operational state of the first system 174 meets or exceeds a parameter threshold.

For the safety feature 220 corresponding to the “operating with no seatbelt” feature (shown in FIG. 4), the controller 176 may be configured to determine an operational state of the seat belt locking system 146 based on the data received from the seat belt sensor 182. In some embodiments, the controller 176 may be configured to receive the data related to the operational state of the seat belt locking system 146 from the work machine's electronic control module (ECM) 178 or any other similar module. In accordance with various embodiments, the operational state of the seat belt locking system 146 may correspond to a locked state (e.g., when the tongue of the seat belt locking system 146 is inserted in the seatbelt buckle assembly) and an unlocked state (e.g., when the tongue of the seat belt locking system 146 is not inserted in the seatbelt buckle assembly). The controller 176 is configured to determine the unlocked state of the seat belt locking system 146 based on the data and issue the one or more correction signals when the operational state of the seat belt locking system 146 corresponds to the unlocked state.

For the safety feature 220 corresponding to the “phone while operating” feature (shown in FIG. 4), the controller 176 may be configured to determine an operational state of the hydraulic system 148 based on the data received from the hydraulic sensor 186. In some embodiments, the controller 176 may be configured to receive the data related to the operational state of the hydraulic system 148 from the machine's ECM 178 or any other similar module. In accordance with various embodiments, the operational state of the hydraulic system 148 may correspond to an engaged state (e.g., when the hydraulic fluid is being pressurized and directed into the hydraulic cylinder 156 to perform a specific function, such as extending a boom or lifting arms) and a disengaged state (e.g., when the hydraulic fluid is not flowing and no functions are being performed). The controller 176 is configured to determine the engaged state of the hydraulic system 148 based on the data and issue the one or more correction signals when the operational state of the hydraulic system 148 corresponds to the engaged state.

For the safety feature 220 corresponding to the “honk at engine start” and “honk before travelling” features (shown in FIG. 4), the controller 176 may be configured to determine an operational state of the machine horn 136 based on the data received from the machine horn sensor 184. In some embodiments, the controller 176 may be configured to receive the data related to the operational state of the machine horn 136 from the machine's ECM 178 or any other similar module. In accordance with various embodiments, the operational state of the machine horn 136 may correspond to an actuated state (e.g., when the machine horn 136 has been activated or is currently sounding) and a deactuated state (e.g., when the machine horn 136 is not activated or sounding).

In an exemplary embodiment, the parameter associated with the machine horn 136 for the “honk at engine start” feature (shown in FIG. 4) may include a first period for which the power system 138 remains in an inactive state from the actuation (i.e., the actuated state) of the machine horn 136. The controller 176 is configured to detect the inactive state of the power system 138 for the first period and issue the one or more correction signals when the first period meets or exceeds a first predefined period (i.e., the parameter threshold). In accordance with various embodiments, the inactive state of the power system 138 corresponds to a non-functional (e.g., an OFF condition) and an active state corresponds to a running or a functional state (e.g., an ON condition) of the power system 138. In accordance with various embodiments, the controller 176 is configured to determine the inactive state of the power system 138 based on signals received from the machine's ECM 178, transducers, or sensors associated with detecting one or more power system parameters of the power system 138. As an example, when the power system 138 includes the internal combustion engine, the power system parameters may include, but not limited to, one or more of a fueling rate, an exhaust flow rate, an output shaft speed, an exhaust gas temperature, and the like of the internal combustion engine of the power system 138.

In another exemplary embodiment, the parameter associated with the machine horn 136 for the “honk before travelling” feature (shown in FIG. 4) may include a second period for which the one or more traction devices 112 remain in a stationary state from the actuation (i.e., the actuated state) of the machine horn 136. The controller 176 is configured to detect the stationary state of the one or more traction devices 112 for the second period and issue the one or more correction signals when the second period meets or exceeds a second predefined period (i.e., the parameter threshold). In accordance with various embodiments, the controller 176 is configured to determine the stationary state of the traction devices 112 based on signals received from the machine's ECM 178, transducers, or one or more sensors configured to detect a state of motion (e.g., machine speed) of the traction devices 112 of the work machine 100. The one or more sensors may include, but not limited to, a position sensor (e.g., Global Positioning Sensor), an accelerometer, and the like for detecting state of the one or more traction devices 112. The one or more sensors may include, but not limited to, a position sensor (e.g., Global Positioning Sensor), an accelerometer, and the like for detecting the state of the one or more traction devices 112. In accordance with various embodiments, the state of the one or more traction devices 112 may correspond to a moving state (e.g., when the one or more traction devices 112 are moving with the machine speed greater than equal to a predefined speed value) and a stationary state (e.g., when the one or more traction devices 112 are not moving or moving with the machine speed less than the predefined speed value).

A person skilled in the art would appreciate that the embodiments discussed herein are exemplary in nature and that various modifications in the safety features 220 associated with various coaching modes 208 fall within the scope of the present disclosure. For example, the safety feature 220 may include other sub-features or a combination of various sub-features, such as, but not limited to, honking before moving the work tool 130, honking before functioning of any of the various systems, subsystems, or components of the work machine 100, etc. Thus, it will be appreciated that the examples listed for the first system 174 and the second system 180 are non-exhaustive and non-limiting.

The controller 176 is configured to issue the one or more correction signals corresponding to the one or more coaching levels 222 (shown in FIG. 4) activated based on the second input. In accordance with various embodiments, the controller 176 is configured to issue a first correction signal in correspondence to the activation of the “warning only” level (shown in FIG. 4) and a second correction signal in correspondence to the activation of the “prevent” level (shown in FIG. 4). The controller 176 may be configured to provide an alert in response to the first correction signal. The alert may be an audio alert, such as beeps or alarms, display alerts, such as visual notifications, or tactile alerts provided on the output device of the work machine 100, or a combination of these.

For example, when the operational state of the seat belt locking system 146 corresponds to the unlocked state, the controller 176 issues the first correction signal to provide an alert on the output device to change the operational state of the seat belt locking system 146 to the locked state before engaging the hydraulic system 148. Similarly, when the operational state of the hydraulic system 148 corresponds to the engaged state, the controller 176 issues the first correction signal to provide an alert on the output device to change the operational state of the hydraulic system 148 to the disengaged state before using the communication device 190. When the parameter associated with the machine horn 136 (i.e., the first period) meets or exceeds the first predefined period, the controller 176 issues the first correction signal to provide an alert on the output device to actuate the machine horn 136 before changing the inactive state of the power system to the active state. When the parameter associated with the machine horn 136 (i.e., the second period) meets or exceeds the second predefined period, the controller 176 issues the first correction signal to provide an alert on the output device to actuate the machine horn 136 before changing the stationary state of the traction devices 112 to the moving state.

When the coaching level 222 corresponds to the “prevent” level (shown in FIG. 4), the controller 176 may be configured to limit or disable operation of at least one second system 180 of the work machine 100 in response to the second correction signal of the one or more correction signals. The second system 180 may include one or more systems, sub-systems, assemblies, or components, such as, but not limited to, the hydraulic system 148, the communication device 190, the power system 138, and the traction devices 112, of the work machine 100. Although FIG. 2 shows the second system 180 as the hydraulic system 148, the communication device 190, the power system 138, and the traction devices 112, it may be contemplated that the second system 180 may include any other assembly, system, sub-system, or component of the work machine 100.

For example, when the operational state of the seat belt locking system 146 corresponds to the unlocked state, the controller 176 issues the second correction signal to lockout an operation of the hydraulic system 148. Similarly, when the operational state of the hydraulic system 148 corresponds to the engaged state, the controller 176 issues the second correction signal to limit or disable the usage of the communication device 190. When the parameter associated with the machine horn 136 (i.e., the first period) meets or exceeds the first predefined period, the controller 176 issues the second correction signal to limit or disable the operation of the power system 138. When the parameter associated with the machine horn 136 (i.e., the second period) meets or exceeds the second predefined period, the controller 176 issues the second correction signal to limit or disable the movement of the one or more traction devices 112.

In an embodiment, when the coaching level 222 corresponds to both the “warning only” and “prevent” levels (shown in FIG. 4), the controller 176 may be configured to simultaneously or in sequence, limit or disable the operation of the second system 180 and provide the alert on the output device, in response to the one or more correction signals. In some embodiments, the controller 176 may be configured to simultaneously or in sequence, limit or disable the operation of the second system 180 and as well as provide the alert on the output device when the coaching level 222 corresponds to any one of the coaching level 222, for example, the “prevent” level or the “warning level”, depending upon the requirement. To this end, the controller 176 may be configured to issue, simultaneously or in sequence, the first correction signal and second correction signal.

In some embodiments, the controller 176 may be configured to provide one or more recommendations via the output device in response to the issuance of the one or more correction signals. The recommendations may include, but not limited to, usage or maintenance of the work machine 100, or behavior or safety of the operator of the work machine 100. For example, the controller 176 may recommend minimizing swing time, means to save fuel, etc. The recommendations may also include reference video tutorials to guide the operator of the work machine 100 to implement the recommendations.

In accordance with various embodiments, the controller 176 is configured to halt an issuance of the one or more correction signals (i.e., the first correction signal and the second correction signal) to disable the alert or recommendation, or enable the operation of the second system 180 of the work machine 100 when the operational state of the first system 174 deviates from the predefined condition or the parameter associated with the operational state of the first system 174 falls below the parameter threshold.

### INDUSTRIAL APPLICABILITY

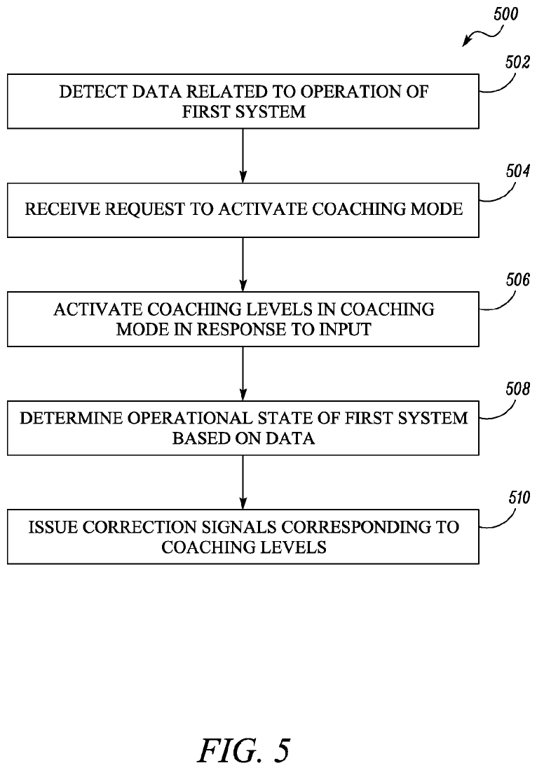

FIG. 5 illustrates a method 500 for coaching the operator of the work machine 100 is described. The method 500 begins with the sensing system 172 detecting the data related to the operation of the first system 174 of the work machine 100, at 502. At 504, the controller 176 receives the first input to activate the coaching mode 208. The controller 176, at 506, then activates the one or more coaching levels from the various coaching levels 222 in the coaching mode 208, 210 in response to the second input. At 508, the controller 176 determines the operational state of the first system 174 based on the data. At 510, the controller 176 issues the correction signals corresponding to the coaching levels when the operational state of the first system 174 meets the predefined condition or when the parameter associated with the operational state of the first system 174 meets or exceeds a parameter threshold.

The controller 176 may be one or more processor, a microprocessor, a microcontroller, an electronic control module (ECM), an electronic control unit (ECU), or any other suitable means for determining the operational state of the first system 174. The controller 176 may be implemented using one or more controller technologies, such as Application Specific Integrated Circuit (ASIC), Reduced Instruction Set Computing (RISC) technology, Complex Instruction Set Computing (CISC) technology or any other similar technology now known or developed in the future.

The present disclosure provides a method and system for onsite coaching of the operator of the work machine 100 to ensure adherence to safety norms and fundamental operating principles of the work machine 100. Moreover, the method and system of the present disclosure provide multiple coaching levels 222 that enable the user (i.e., the operator or a worksite supervisor or any interested personnel) to select and implement a coaching level 222 based on the requirement or experience of the operator.

It will be apparent to those skilled in the art that various modifications and variations can be made to the method and/or system of the present disclosure without departing from the scope of the disclosure. Other embodiments will be apparent to those skilled in the art from consideration of the specification and practice of the method and/or system disclosed herein. It is intended that the specification and examples be considered as exemplary only, with a true scope of the disclosure being indicated by the following claims and their equivalent.

1. A system for coaching an operator of a work machine, the system comprising:
a sensing system configured to detect data related to an operation of at least one first system of the work machine;
a controller operatively coupled to the sensing system, the controller configured to:
receive a first input to activate a coaching mode;
activate one or more coaching levels from a plurality of coaching levels in the coaching mode in response to a second input;
determine an operational state of the at least one first system based on the data; and
issue one or more correction signals corresponding to the one or more coaching levels when the operational state of the at least one first system meets a predefined condition or when a parameter associated with the operational state of the at least one first system meets or exceeds a parameter threshold.

2. The system of claim 1, further including:
an output device, wherein the controller is configured to provide an alert on the output device in response to a first correction signal of the one or more correction signals, wherein the first correction signal is issued in correspondence to activating a first coaching level of the plurality of coaching levels.

3. The system of claim 1, wherein the controller is configured to limit or disable operation of at least one second system of the work machine in response to a second correction signal of the one or more correction signals, wherein the second correction signal is issued in correspondence to activating a second coaching level of the plurality of coaching levels.

4. The system of claim 3, wherein the controller is configured to halt an issuance of the second correction signal to enable the operation of the at least one second system of the work machine when the operational state of the at least one first system deviates from the predefined condition or the parameter associated with the operational state of the at least one first system falls below the parameter threshold.

5. The system of claim 1, wherein, in response to the one or more correction signals, the controller is configured to, simultaneously or in sequence:
limit or disable an operation of at least one second system and provide an alert on an output device.

6. The system of claim 3, wherein the at least one first system includes a seat belt locking system and the at least one second system includes a hydraulic system, and when the operational state corresponds to an unlocked state of the seat belt locking system, the controller issues the second correction signal to lockout an operation of the hydraulic system.

7. The system of claim 3, wherein the at least one first system includes a hydraulic system and the at least one second system includes a communication device, and when the operational state corresponds to an engaged state of the hydraulic system, the controller issues the second correction signal to limit or disable the usage of the communication device.

8. The system of claim 3, wherein the at least one first system includes a machine horn and the at least one second system includes a power system, and the parameter associated with the machine horn includes a first period for which the power system remains in an inactive state from an actuation of the machine horn,
wherein the parameter threshold corresponds to a first predefined period and the controller is configured to issue the second correction signal to limit or disable the operation of the power system when the first period meets or exceeds the first predefined period.

9. The system of claim 3, wherein the at least one first system includes a machine horn and the at least one second system includes one or more traction devices, and the parameter associated with the machine horn includes a second period for which the one or more traction devices remains in a stationary state from an actuation of the machine horn,
wherein the parameter threshold corresponds to a second predefined period and the controller is configured to issue the second correction signal to limit or disable the movement of the one or more traction devices when the second period meets or exceeds the second predefined period.

10. The system of claim 1, further including:
an output device, wherein the controller is configured to provide one or more recommendations via the output device in response to an issuance of the one or more correction signals.

11. A method for coaching an operator of a work machine, the method comprising:
detecting, by a sensing system, data related to an operation of at least one first system of the work machine;
receiving, by a controller, a first input to activate a coaching mode;
activating, by the controller, one or more coaching levels from a plurality of coaching levels in the coaching mode in response to a second input;
determining, by the controller, an operational state of the at least one first system based on the data; and
issuing, by the controller, one or more correction signals corresponding to the one or more coaching levels when the operational state of the at least one first system meets a predefined condition or when a parameter associated with the operational state of the at least one first system meets or exceeds a parameter threshold.

12. The method of claim 11, further including:
providing, by the controller, an alert on an output device in response to a first correction signal of the one or more correction signals, wherein the first correction signal is issued in correspondence to activating a first coaching level of the plurality of coaching levels.

13. The method of claim 11, further including:
limiting or disabling, by the controller, operation of at least one second system of the work machine in response to a second correction signal of the one or more correction signals, wherein the second correction signal is issued in correspondence to activating a second coaching level of the plurality of coaching levels.

14. The method of claim 13, further including:
halting, by the controller, an issuance of the second correction signal to enable the operation of the at least one second system of the work machine when the operational state of the at least one first system deviates from the predefined condition or the parameter associated with the operational state of the at least one first system falls below the parameter threshold.

15. The method of claim 11, further including:
in response to the one or more correction signals:
simultaneously or in sequence, limiting or disabling, by the controller, an operation of at least one second system and provide an alert on an output device.

16. The method of claim 13, wherein the at least one first system includes a seat belt locking system and the at least one second system includes a hydraulic system, and when the operational state corresponds to an unlocked state of the seat belt locking system, the controller issues the second correction signal to lockout an operation of the hydraulic system.

17. The method of claim 13, wherein the at least one first system includes a hydraulic system and the at least one second system includes a communication device, and when the operational state corresponds to an engaged state of the hydraulic system, the controller issues the second correction signal to limit or disable the usage of the communication device.

18. The method of claim 13, wherein the at least one first system includes a machine horn and the at least one second system includes a power system, and the parameter associated with the machine horn includes a first period for which the power system remains in an inactive state from an actuation of the machine horn,
wherein the parameter threshold corresponds to a first predefined period and the controller is configured to issue the second correction signal to limit or disable the operation of the power system when the first period meets or exceeds the first predefined period.

19. The method of claim 13, wherein the at least one first system includes a machine horn and the at least one second system includes one or more traction devices, and the parameter associated with the machine horn includes a second period for which the one or more traction devices remains in a stationary state from an actuation of the machine horn,
wherein the parameter threshold corresponds to a second predefined period and the controller is configured to issue the second correction signal to limit or disable the movement of the one or more traction devices when the second period meets or exceeds the second predefined period.

20. The method of claim 11, further including:
providing, by the controller, one or more recommendations via an output device in response to an issuance of the one or more correction signals.
